(19) United States
(12) Patent Application Publication
(10) Pub. No.: US 2005/0232169 A1
(43) Pub. Date: Oct. 20, 2005

(54) System and method for providing telecommunication relay services

(75) Inventors: Thomas J. McLaughlin, Salt Lake City, UT (US); Alan S. Call, Salt Lake City, UT (US); Paul R. Daugherty, Park City, UT (US); Casey T. Wright, Salt Lake City, UT (US); Ron Nelson, Salt Lake City, UT (US)

Correspondence Address: STOEL RIVES LLP - SLC, 201 SOUTH MAIN STREET, ONE UTAH CENTER, SALT LAKE CITY, UT, 84111, US

(73) Assignee: NXi Communications, Inc.

(21) Appl. No.: 11/106,800

(22) Filed: Apr. 15, 2005

Related U.S. Application Data
(60) Provisional application No. 60/562,795, filed on Apr. 16, 2004.

(51) Int. Cl. H04Q 11/00

(52) U.S. Cl. 370/261

(57) ABSTRACT

A system and method disclosed herein detects calls to determine compatibility with a destination number. If the call is incompatible then relay services may be required to provide voice/text translation. A request is automatically sent to a call center to provide relay services. A relay operator at the call center is instructed to return the request. The relay operator responds with a relay call that is joined to the original call. The destination number is then joined to the original call and relay communication may proceed.

### RELATED APPLICATIONS

This application claims priority to U.S. Provisional Patent Application No. 60/562,795 filed on Apr. 16, 2004 and entitled “System and Method for Text/Voice Network Communication,” and which is hereby incorporated by reference.

### TECHNICAL FIELD

The present invention relates to relay-assisted telecommunication for the hearing and speech-impaired.

### BRIEF DESCRIPTION OF THE DRAWINGS

Various embodiments of the invention are now described with reference to the figures, in which:

FIG. 1 is a block diagram of an embodiment of a system of the present invention.

FIG. 2 is a flow diagram of a process performed in accordance with the present invention.

FIG. 3 is a flow diagram of a process performed in accordance with the present invention.

FIG. 4 is a block diagram illustrating communication in a conference call with relay service.

FIG. 5 is a block diagram illustrating alternative communication in a conference call with relay service.

FIG. 6 is a block diagram illustrating alternative communication in a conference call with relay service.

### DETAILED DESCRIPTION

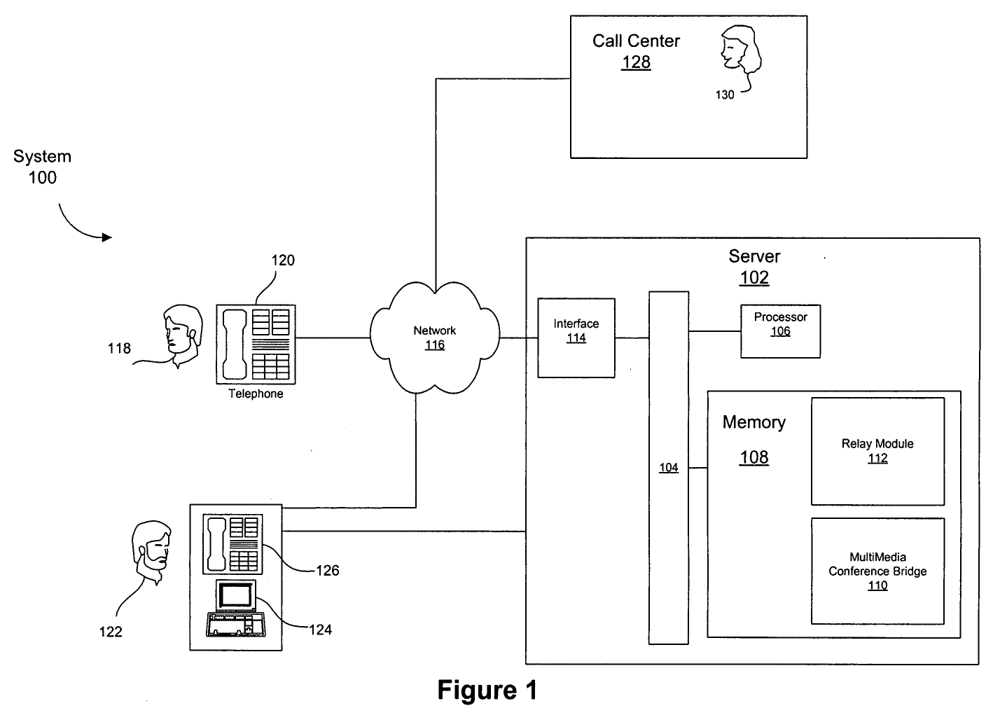

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 6, is not intended to limit the scope of the invention, as claimed, but is merely representative of presently preferred embodiments of the invention.

Parts of the description will be presented in terms of operations performed through the execution of programming instructions. As well understood by those skilled in the art, these operations often take the form of electrical, magnetic, or optical signals capable of being stored, transferred, combined, and otherwise manipulated through, for instance, electrical components. Various operations will be described as multiple discrete steps performed in turn in a manner that is helpful in understanding the present invention. However, the order of description should not be construed as to imply that these operations are necessarily performed in the order they are presented, or even order dependent.

Embodiments of the invention may be represented as a software code resident on a computer readable medium (also referred to as a machine-accessible medium, computer-accessible medium, or a processor-accessible medium). The computer readable medium may be any type of magnetic, optical, or electrical storage medium including a diskette, CD-ROM, memory device (volatile or non-volatile), or similar storage mechanism. The computer readable medium may contain various sets of instructions, code sequences, configuration information, or other data. Those of ordinary skill in the art will appreciate that other instructions and operations necessary to implement the described invention may also be stored on the computer readable medium.

As the population ages, there are an increasing number of users who are in stages of hearing loss. Hearing or speech-impaired people need to speak to the hearing/speaking world by telephone as part of their employment, social interaction, and to have access to goods and services. TTY refers to a teletypewriter or telecommunications device for the deaf. A TTY typically communicates using baudot tones at 45 or 50 baud. A TTY may also communicate at higher speed, connections and at protocols, such as Bell 103, V.21, Turbocode, and the like. Although the TTY provides telecommunication capability, it cannot communicate with a conventional voice telephone. Telephone conversations with the hearing and speech-impaired are made possible through conventional relay services maintained by telephone companies. In a conventional relay call for the hearing or speech-impaired, the originating caller must first call a relay operator. A relay operator responds to mediate the call and calls the call recipient. The relay operator reads incoming text from a speech-impaired user and voices this text to the hearing user. Similarly, the relay operator listens to the speaking party and types what is said to the deaf party.

Relay calls have made a tremendous impact in the lives of the hearing and speech-impaired, but existing technology and techniques are not optimal. A hearing/speaking person cannot call directly to a hearing or speech-impaired person but instead must call a relay service and ask the relay operator to call the desired party. This procedure is cumbersome, and it is generally difficult to convey information on this procedure to the hearing/speaking person. A hearing or speech-impaired person also receives a number of TTY calls, fax calls, and voice calls. Conventional products do not automatically detect whether an incoming call is from a TTY or voice caller. This creates frustration for both the voice caller and the hearing or speech-impaired person. A hearing/speaking caller will be answered by TTY tones and may not understand as to how to proceed. A hearing or speech-impaired person may receive voice phone calls to which they cannot respond.

The present invention includes the use of a multimedia conference bridge and a “relay-on-demand” technique to facilitate relay calls. Callers generate calls to numbers owned or mapped to specific users. These calls are directed to a multimedia conference bridge to detect if relay services are required. If the multimedia conference bridge detects a disparity in the party's capabilities, e.g., a party is hearing and speaking and the other is hearing or speech-impaired, then the conference bridge automatically places a call to a relay operator. The relay operator is instructed to return a call back to the conference call. The multimedia conference bridge intercepts the relay operator's return call and adds the relay operator to the original conference call.

Referring to FIG. 1, a system 100 is shown in which the present invention may operate. The system 100 includes a server 102 that may be embodied as a computer system architecture, although other processor, programmable or electronic-based devices may also be employed. The server may include a bus 104 for communicating information and a processor 106 coupled with the bus 104 for executing code and processing information. The bus architecture employed by the server 102 may be shared bus architecture. The processor 106 may be any of a wide variety of general purpose processors, microprocessors, or micro-controllers such as the Pentium® processor manufactured by Intel® Corporation. It will be apparent to those of ordinary skill in the art, however, that other varieties of processors may also be used.

A memory 108 is coupled with the bus 104 for storing data and executable instructions for the processor 106. The memory 108 may include a read-only memory for storing static information and instructions, a random access memory for short-term storage, and a non-volatile long-term memory. The non-volatile memory may include a conventional hard disk drive, floppy disk drive, CD-ROM drive, or other magnetic or optical data storage device for reading and writing information stored on a hard disk, a floppy disk, a CD-ROM a magnetic tape, or other magnetic or optical data storage medium.

The memory 108 includes a multimedia conference bridge 110 that includes instruction code for creating communication conferences. Parties to a conference may have varying equipment capabilities, such as the ability to send/receive text, audio, and/or video data. The capabilities include the ability to send and/or receive voice, text, and video based media types. A user may have the ability to send, or receive, a given media type in just one direction and not both directions, or may not be capable of this media type in either direction. For example, a deaf user may be able to speak and send voice sounds but not hear and receive voice sounds. A user may be able to receive and display a video media type, but not have a camera and therefore not able to send video information.

The multimedia conference bridge 110 can detect the media type for users calling into the server 102 or being called by the server 102. In one embodiment, the multimedia conference bridge 110 transmits a voice recording requesting that a user press a key on a telephone dialing keypad. For example, the conference bridge 110 may send a voice prompt saying “please press one.” The conference bridge 110 then detects if a dual tone multi-frequency (DTMF) is received. If a user presses “one,” a DTMF tone is generated and detected by the conference bridge 110. The conference bridge 110 can interpret this signal as evidence that the user can hear.

In an alternative embodiment, the conference bridge 110 listens for characteristic tones used by TTYs or modems (referred to herein as text tones). These text tones are documented in the International Telecommunications Union (ITU) V.18 standard. The presence of any of these tones on an inbound or outbound call means the user is using a text device.

In an alternative embodiment, the conference bridge 110 listens for voice sounds. The presence of voice sounds on the call means the user can speak. With speech recognition technology the conference bridge 110 can also turn voice sounds into text. For example, the conference bridge 110 can play a voice recording saying “please say, or press, one.” If the conference bridge 110 then receives a DTMF “one,” or voice sound saying “one,” then the conference bridge 100 can determine that the user can hear, at least to some degree. It is noted that some users can hear but are hard-of-hearing. The conference bridge 110 can expand the prompt above to say “if you would like relay services on this call, please say or press one. If you do not require relay services on this call, please say, or press, two.” On an outbound call, if a user answers by voice by saying “hello” or similar, then the conference bridge 110 can interpret these sounds to mean the remote person can talk and can probably hear as well.

In yet another embodiment, the conference bridge 110 performs a database lookup on the user based on information available on the call. A call into, or from, the server 102 can include information on the calling or called party. The conference bridge 110 consults pre-stored information concerning either party to determine pre-stored information on the capabilities of a user. The pre-stored information may be available within a telephone system, Lightweight Directory Access Protocol database, or other type of databases.

For example, a phone call into the server 102 may include caller identification, or automatic number identification (ANI), which is the phone number of the calling party on a telephone line. A database lookup on this number may provide pre-stored information on the capabilities of the calling user.

If the conference bridge 110 calls out to a phone number, the conference bridge 110 may perform a database lookup on the called number through dialed number identification service (DNIS) or direct inward dial (DID). The database lookup returns with pre-stored information on the capabilities of the called party.

In another technique, a data network call into, or out of, the server 102 may include an Internet Protocol (IP) address of the user. A database lookup on the IP address may provide information on the capabilities of the remote user.

The call itself may include information on the capabilities of the person. This information may be available during call setup, or may be provided in an automated fashion during the call negotiation phase. For example, an inbound phone call may include additional information on the user's capabilities in fields such as the Q.931 user user information (UUI) field, or other fields used in SS7 or ISDN signaling. In another example, an inbound call from a data network may include information on the user's capabilities in data fields used in call setup. For example, the session initiated protocol (SIP) or H.323 protocol, can include such information in data fields used in call setup from a data network. Alternatively, inbound or outbound calls between the server 102 and a remote site over a data network may support a negotiation phase where the capabilities of both sides of the connection are exchanged. The SIP protocol or H.323 protocol mentioned above support this type of negotiation. In yet another example, a telephone system may be programmed to transmit a unique user code using DTMF tones for a calling, or called, party. The conference bridge 110 uses the unique user code to perform a database lookup to ascertain the user's capabilities. In another technique, conference bridge 110 may interact with a phone system using Computer Telephony Integration (CTI) techniques to access stored information on a calling, or called, telephone user.

The techniques discussed above may be used in isolation, or jointly, on one or multiple calls from, or into, the conference bridge. For example, a database lookup technique may be used on just an inbound caller, or just the outbound call from the conference bridge, or both. Detecting DTMF tones, text tones, or voice sounds may be performed on just an inbound caller, just the outbound call from the server 102, or both. As can be appreciated by one of skill in the art, these techniques may be combined in a variety of combinations all of which are included within the scope of the invention.

The multimedia conference bridge 110 establishes a conference and ensures that all parties in the conference receive the data that their corresponding equipment is capable of handling. Thus, audio is not sent to a text-only device and text is not sent to an audio-only device. The conference bridge 110 is capable of supporting a conference call with two, three, or more parties. Two or more users may be compatible with each other, but one user may not be compatible. The conference bridge 110 detects the incompatibility of a user to determine if relay services are required.

The memory 108 further includes a relay module 112 to provide a relay service as needed during a conference. Upon detection of incompatibility by the multimedia conference bridge 110, the relay module 112 conferences in a relay service in a transparent manner.

An interface device 114 is in electrical communication with the bus 104 to provide communication with a network 116. The network 116 may be a LAN, WAN, PSTN, Internet, data network, or a combination thereof. The network 116 provides communication between telephones, facsimile machines, TTY, wireless devices, and the like.

A voice user 118 operates a voice telephone 120 to communicate with an impaired user 122. The impaired user 122 may have partial or complete hearing impairment in which case the impaired user 122 may operate a text device 124. The text device 124 may include a TTY, personal computer with a web browser, PDA, or other device capable of reading or generating text data. A hearing-impaired user 122 may operate a telephone 126 to deliver voice and read text from the text device 124. The text is received from a relay operator who translates the text from voice. A hearing-impaired user may also participate in a voice carry-over (VCO) technique wherein the hearing-impaired user receives both voice and text. The text provides real time closed captioning of what the other party is saying. The text assists the impaired user 122 who is capable of limited hearing. VCO techniques may be applied to any number of telephones and text devices. In one embodiment, the conventional telephone 126 manages the voice while a text channel is transmitted to a separate text device.

In an alternative embodiment, the telephone 126 is embodied as a specialized telephone that manages both voice and text data. The telephone 126 provides voice and includes a display to show readable text. Some conventional telephones include an addressable display and may be incorporated into the teachings of the present invention. For example, telephones manufactured by Cisco® include XML addressable displays. An impaired user 122 with partial hearing may listen to the voice and review the displayed text to supplement the user's understanding.

If the user 122 is speech-impaired, then the user 122 may use the text device 124 to generate text and a conventional telephone 126 to receive voice. Alternatively, the text device 124 may include a microphone and supporting hardware to convey voice. The telephone 126 may also be embodied to manage voice and text by including a display and an input device to enter text. Preferably an input device would provide full or nearly full keyboard operation to facilitate text entry.

The impaired user's equipment, 124, 126, may be directly in communication with the server 102 or may be in communication with the server 102 through the network 116. In another embodiment, the server 102 may be incorporated within the impaired user's equipment, such as the text device 124. Such an embodiment is easily rendered where the text device 124 is embodied as a general or special purpose computer. Thus, the text device 124 would provide all functions performed by the server 102.

The system 100 includes the use of a call center 128 that is defined broadly to include the virtual and/or physical location of a relay operator 130. As a call is made between the unimpaired user 118 to the impaired user 122, the multimedia conference bridge 110 establishes a conference and detects equipment incompatibility. If incompatibility exists, the relay module 112 notifies the call center 128 and a relay operator 130 is invited into the conference to mediate. The relay operator 130 is able to provide text-to-voice and voice-to-text interpretation as needed to enable communication.

The call center 128 may include hardware and software equipment to improve VCO techniques. VCO calls may be supported through a variety of hardware devices. The call center 128 may include voice recognition technology to assist the relay operator in keeping up with a speaking party. Alternatively, a relay operator 130 may use a stenographer keyboard to maintain the voice pace. As can be appreciated, the use of the equipment to assist VCO is transparent for users.

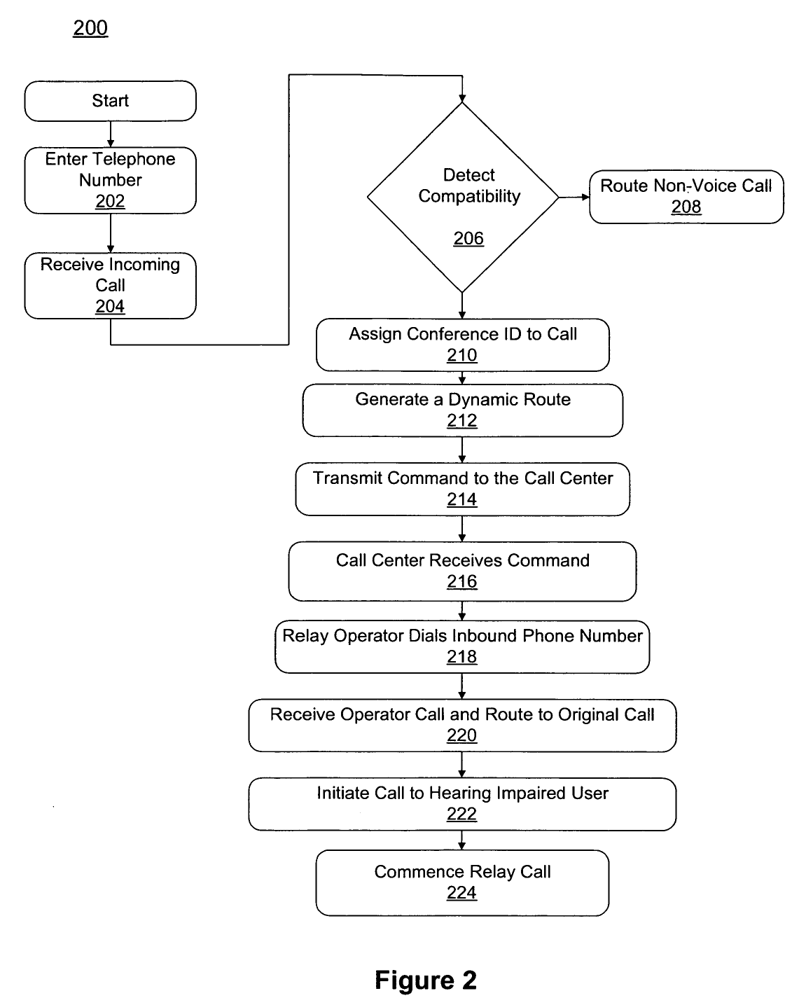

Referring to FIG. 2, and with continued reference to FIG. 1, a flow diagram illustrates a process 200 performed in a hearing to hearing-impaired call. The user 118 enters 202 a telephone number on the telephone 120 that is routed to and received by the server 102. The telephone 120 may be associated with an originating telephone number and the dialed number is referenced as the destination number. In one embodiment, the server 102 may provide access and service to a plurality of call stations within a LAN.

The server 102 receives 204 the incoming call, which may be any type of call, whether on telephone lines or any type of data network. The incoming call may be routed to the server 102 as part of a subscribed service. Alternatively, access to the impaired user 122 may be through a network. The server 102 may play an audio recording to indicate further action on the part of the hearing user. For example, the audio recording may state “please press any key to continue,” “enter the party's extension,” or “dial one please,” etc. Alternatively, the server 102 may not provide an audio recording.

The multimedia conference bridge 110 detects 206 the compatibility of the incoming call. As discussed above, detection of the incoming call compatibility may be based on a correct DTMF response, voice response, text tones, database lookup, or data fields in the incoming call itself. Thus, detection of the incoming call compatibility may be based on the user's personal capability, on the equipment 120, pre-stored information, or information within the call itself.

Upon detection that a text call is received, the text call is routed 208 to the text device 124 in a routine manner.

If the call is a voice call, then relay service is required. The multimedia conference bridge 110 assigns 210 a conference identification to the current call. The relay module 112 generates 212 a dynamic route to map an inbound phone number to the conference identification of the current call. The relay module 112 transmits 214 a command, which includes the inbound phone number, to the call center 128. The command indicates to the call center 128 that a current call requires a relay service.

The relay operator 130 at the call center 128 receives 216 the command. The command includes text to notify the relay operator 130 of the situation and convey the inbound phone number. The text may state “hello, please dial 1-800-555-4535 ga” or some similar recording. The relay operator 130 dials 218 the recited inbound phone number. The multimedia conference bridge 110 receives 220 the operator call and, based on the established dynamic route, routes the operator call to the original call. At this point, the operator can talk to the voice user.

The multimedia conference bridge 110 initiates 222 a call to the hearing-impaired user 122. If the hearing-impaired user 122 is not a VCO user, then this call leg will be text only. If the hearing-impaired user 122 is a VCO user, then the multimedia conference bridge 110 generates two call legs: (1) a voice call to the telephone 126; and (2) a text call to the text device 124. In certain embodiments, the text device 124 may be included within the telephone 126. The multimedia conference bridge 110 correctly maps both the voice and text streams and once the voice and text streams are configured correctly, then the relay call may commence 224. The hearing user voice is received by the relay operator 130 who then enters the voice as text. The text is then sent to the text device 124. The voice sounds may also be sent to the telephone 126 in a VCO process.

In the method 200, the voice user 118 only needs to dial a destination number to begin a relay call. The process proceeds transparently to the voice user 118 although some small delay occurs as the relay operator 130 is introduced. From the operator's perspective, the operator receives and dials an inbound phone number and encounters a hearing user. Once the hearing-impaired user answers, the operator performs a function as in conventional relay service. From the hearing-impaired user's perspective, the process is completely transparent.

In an alternative embodiment, the multimedia conference bridge 110 may accept an incoming voice call and transmit a “please hold” voice message to the voice user 118. The multimedia conference bridge 110 generates an outbound call to the hearing-impaired user 122. When the hearing-impaired user 122 answers, then the relay module 112 calls to the call center 128 as described above to introduce the relay operator 130. This introduces a delay for the hearing-impaired user 122.

Different techniques may be used to intercept the relay operator return call and add this call to the original call. As discussed, the relay operator 130 may be instructed to dial a specific number and/or extension number generated by the multimedia conference bridge 110. The specific number may be used as a unique conference identification. Alternatively, the impaired user 122 and equipment 124, 126 may be part of an organization. If the organization has a range of incoming phone numbers available, the multimedia conference bridge 110 can designate one of them for use by the relay operator 130. When the organization receives a call on the designated number, the organization automatically directs the call to the multimedia conference bridge 110. The multimedia conference bridge 110 then includes the operator call in the conference call.

In another implementation, the multimedia conference bridge 110 may include a unique conference identification in a UUI field in an ISDN connection. This requires that the relay operator 130 be capable of reading from and writing to this field. Once the relay operator 130 has joined the call, the multimedia conference bridge 110 manages the tasks of sending voice data between the voice user 118 and the relay operator 130 and sending text data between the impaired user 122 and the relay operator 130.

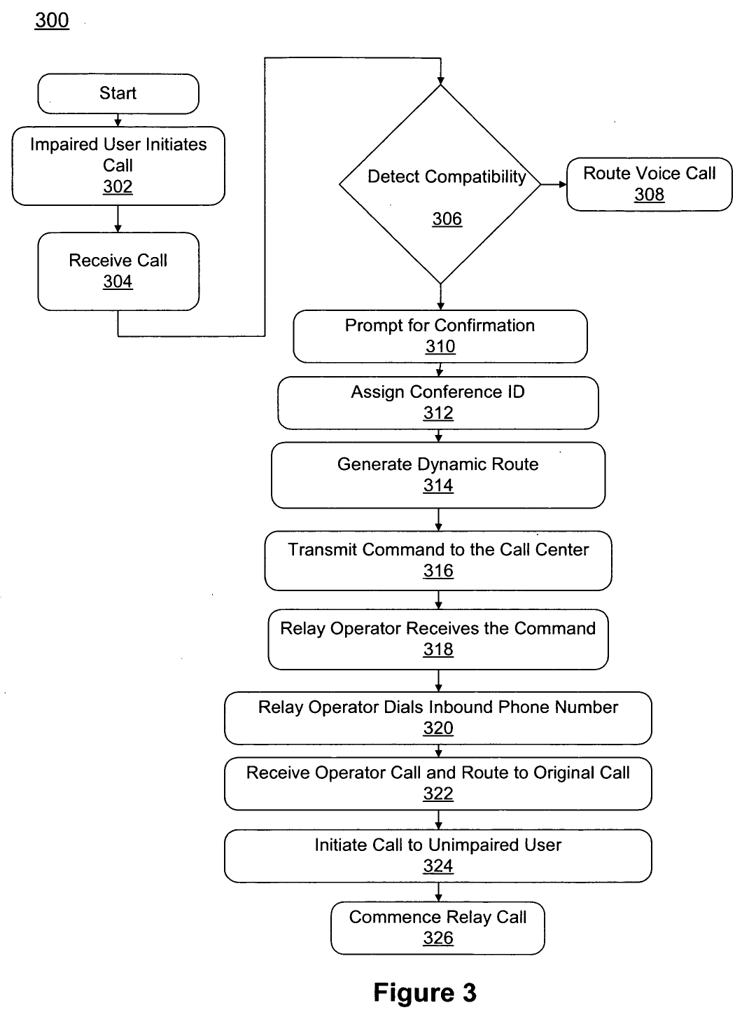

Referring to FIG. 3, a flow diagram illustrates a process 300 performed in a hearing-impaired to hearing call. The hearing-impaired user 122 initiates 302 an outbound call that is received 304 by the multimedia conference bridge 110. The outbound call may be routed to the server 102 as part of a service to which the impaired user 122 has subscribed.

The multimedia conference bridge 110 detects 306 compatibility and if relay assistance is required. This may be accomplished by using any one of a number of methods discussed above alone or in combination. The impaired user 122 may use a text device 124 to initiate the outbound call. If the call is a voice call, then the call is routed 308 to a destination number.

If the call is a text call, then the multimedia conference bridge 110 may optionally prompt 310 the impaired user 122 for a confirmation. The multimedia conference bridge 110 may respond with a text greeting, such as “this is a text call . . . for relay services, kindly press any key” or similar words. The impaired user 122 may not initiate a relay service if the impaired user 122 knows that the destination is to another text device.

In an alternative implementation, an impaired user 122 may dial an outbound call with a voice telephone 126. This may occur where the impaired user 122 is hard-of-hearing or even speech-impaired but not hearing-impaired. The multimedia conference bridge 110 may provide a menu with prerecorded messages. The impaired user 122 may be asked to select if relay assistance is desired. The impaired user 122 may enter responses by pressing DTMF keys on a voice telephone 126. During a relay call, the impaired user 122 will use a text device 124 as well to either assist in what a voice user is saying or to enter text responses.

If an impaired user 122 requests relay assistance, then the relay module 112 creates a call to the call center 128 in a manner described above. This includes the multimedia conference bridge 110 assigning 312 a conference identification to the current call, the relay module 112 generating 314 a dynamic route to map an inbound phone number to the conference identification of the current call, and the relay module 112 transmitting 316 a command to the call center 128. The relay operator 130 receives 318 the command and dials 320 the inbound phone number. The multimedia conference bridge 110 receives 322 the operator call and routes the operator call to the original call.

The multimedia conference bridge 110 initiates 324 a call to the unimpaired user 118. The multimedia conference bridge 110 configures and maps the voice and text streams to commence 326 the relay call. If the hearing-impaired user 122 is not a VCO user, then multimedia conference bridge 110 generates a text-only call leg with the call center 128. If the hearing-impaired user 122 is a VCO user, then the multimedia conference bridge 110 generates a voice-call leg with the voice user 118 and a text-call leg with the call center 128.

The present invention has application for a speech-impaired user who is capable of listening. A speech-impaired user may require a relay service for hearing carry-over (HCO) service. Two call legs, one for text and the second for voice, may be established between the call center 128 and the impaired user 122. Introduction of a relay service is similar to the techniques discussed above. A voice user 118 without a text-capable device will require a relay service. When the voice user 118 dials into the server 102 the multimedia conference bridge 110 detects this incompatibility and initiates relay service. When the impaired user 122 dials into the server 102, the impaired user 122 may do so with a voice telephone or a text device. If the impaired user 122 dials in with a voice telephone 126, the server 102 allows the user 122 to select relay service. If the impaired user 122 dials in with text device 124, the server 102 detects the text device and may initiate a relay service. The impaired user 122 may decline relay service if an outbound call is to another text device.

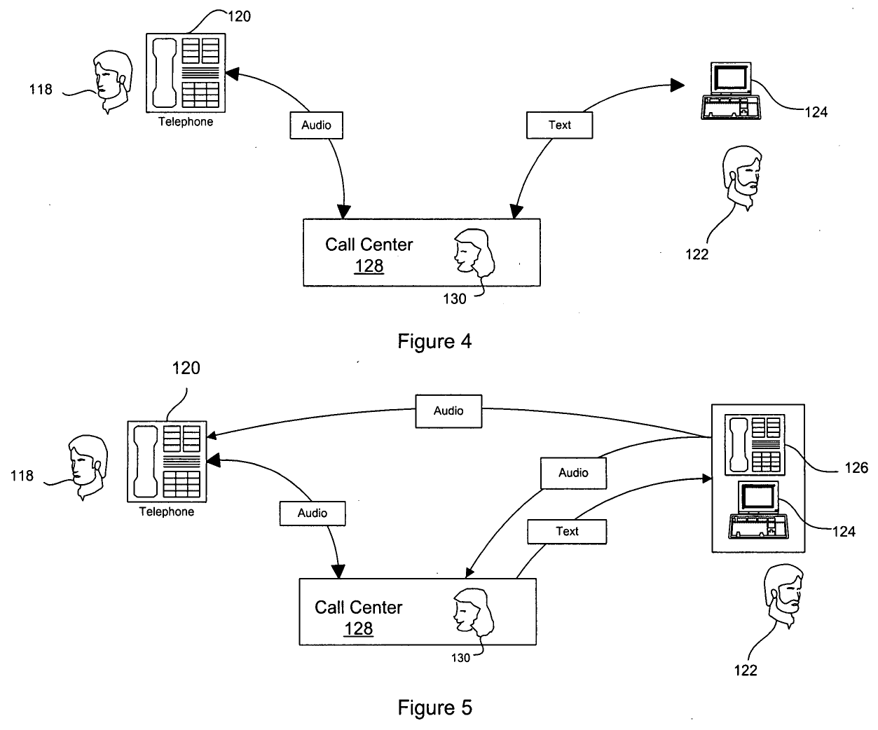

Referring to FIG. 4 a block diagram is shown of a relay-assisted conference call. Voice audio is communicated between the voice user 118 and the call center 128. The relay operator 130 listens to the voice and enters written text to the impaired user 122. The relay operator 130 may be assisted by voice recognition software. The impaired user 122 communicates with the call center 128 by text which is then read to the voice user 118. This technique may be used for both a hearing-impaired or speech-impaired user.

Referring to FIG. 5, a block diagram illustrates a relay-assisted conference call with a hearing-impaired user 122. Voice audio is communicated between the voice user 118 and the call center 128 as before. The hearing-impaired user communicates with the call center 128 by sending voice and receiving text. The hearing-impaired user 122 further transmits audio to the voice user 118 as the hearing-impaired user may be capable of speech. The user 122 may use two separate devices 124, 126 or a single device that enables both audio and text communication. The conference call may be configured to accommodate a VCO technique wherein the hearing-impaired user 122 receives audio from the voice caller 118 and the relay operator 130. This is advantageous where the hearing-impaired user 122 is hard-of-hearing and not deaf. The hearing-impaired user receives voice from the voice user 118 and nearly simultaneously receives text to serve as closed captioning.

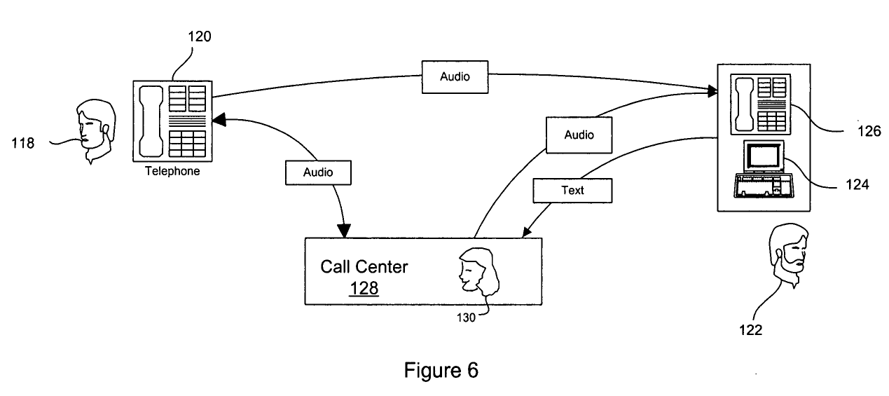

Referring to FIG. 6, a block diagram illustrates a relay-assisted conference call with a speech-impaired user 122. The speech-impaired user 122 receives audio from the voice user 118 and the call center 128 and responds with text from a text device 124. The conference call may further accommodate an HCO technique wherein audio is also conveyed to the voice user 118 and to the relay operator 130. The speech-impaired user 122 may have partial speech impairment. The speech-impaired user 122 may both write and speak. The limited speech may be assisted by voice from the relay operator.

Although FIGS. 4-6 illustrate two parties and a relay operator participating in a call, the present invention has application to conference calls with three or more parties. For example, two compatible parties may be joined in a call by the multimedia conference bridge 110. The compatible parties may enter a destination number to join a third incompatible party. Upon receiving the destination number, the multimedia conference bridge determines that relay service is required and initiate such service before joining the incompatible party. With three or more parties, the multimedia conference bridge 110 continues to perform text and audio streaming between the parties and the relay operator to maintain compatible communication.

As can be appreciated, the conveyance of text and audio in a relay conference may vary depending on the hearing and/or speech impairment of the user and still be included within the scope of the invention. The present invention provides an efficient and transparent technique for establishing a relay conference call. A server detects if an outbound call is compatible with destination equipment. If incompatibility is detected, the server automatically calls in a relay service. The term automatically signifies that direct human action is not required. The present invention supports VCO and HCO techniques as well as VCO operator-assisted techniques.

Embodiments of the present invention include various steps which have been described above. The steps may be embodied in machine-executable instructions which may be used to cause a general purpose or special purpose processor to perform the steps. Alternatively, these steps may be performed by specific hardware components that contain hardwired logic for performing the steps, or by any combination of programmed computer components and custom hardware components.

Elements of the present invention may also be provided as a computer program product that may include a computer readable medium having stored thereon instructions that may be used to program a computer, or other electronic device, to perform a process. The computer readable medium may include, but is not limited to, optical disks, CD-ROMs, DVD, floppy diskettes, magneto-optical disks, ROMs, RAMs, EPROMs, EEPROMs, magnet or optical cards, propagation media or other type of media/machine readable mediums suitable for storing electronic instructions. For example, the present invention may be downloaded as a computer program product, wherein the program may be transferred from a remote computer to a requesting or client computer by way of data signals embodied in a carrier wave or other propagation medium via a communication link.

While specific embodiments and applications of the present invention have been illustrated and described, it is to be understood that the invention is not limited to the precise configuration and components disclosed herein. Various modifications, changes, and variations apparent to those of skill in the art may be made in the arrangement, operation, and details of the methods and systems of the present invention disclosed herein without departing from the spirit and scope of the present invention.

1. A method for conferencing in a relay service into a call between a user and an impaired user, comprising:
receiving an original call from an originating number;
determining if the original call is compatible with a destination number;
upon determining incompatibility, placing a request call to a call center to request relay service to provide voice translation of text communication;
receiving a relay call from the call center and conferencing the relay call into the original call; and
connecting the original call to the destination number.

2. The method of claim 1, wherein placing a request call includes,
mapping a conference identification to the original call, and
transmitting a conference identification to the call center,
wherein receiving the relay call includes receiving the conference identification.

3. The method of claim 2, wherein the conference identification includes a telephone number.

4. The method of claim 2, wherein the conference identification includes an extension.

5. The method of claim 1, wherein the original call is a voice call and the destination number is compatible with text.

6. The method of claim 1, wherein the original call is a text call and the destination number is compatible with voice.

7. The method of claim 6, wherein determining if the original call is compatible with the destination number includes prompting a user for a request for relay service.

8. The method of claim 1, wherein determining if the original call is compatible with the destination number includes receiving a DTMF response.

9. The method of claim 1, wherein determining if the original call is compatible with the destination number includes receiving a voice response.

10. The method of claim 1, wherein determining if the original call is compatible with the destination number includes detecting text tones in the original call.

11. The method of claim 1, wherein determining if the original call is compatible with the destination number includes accessing a database to retrieve pre-stored information associated with the originating number.

12. The method of claim 1, wherein determining if the original call is compatible with the destination number includes detecting information within data fields of the original.

13. The method of claim 1, wherein connecting the original call to the destination number includes enabling voice and text communication between the call center and the destination number.

14. The method of claim 13, further comprising displaying text received from the call center on an addressable telephone display associated with the destination number.

15. The method of claim 1, wherein connecting the original call to the destination number includes enabling voice communication between the originating number and the destination number.

16. A system for conferencing a relay service into a call between a user and an impaired user, comprising:
a processor; and
a memory in electrical communication with the processor and having stored thereon computer executable modules for performing a method comprising:
receiving an original call from an originating number;
determining if the original call is compatible with a destination number;
upon determining incompatibility, placing a request call to a call center to request relay service to provide voice translation of text communication;
receiving a relay call from the call center and conferencing the relay call into the original call; and
connecting the original call to the destination number.

17. The system of claim 16, wherein placing a request call includes,
mapping a conference identification to the original call, and
transmitting a conference identification to the call center, and
wherein receiving the relay call includes receiving the conference identification.

18. The system of claim 17, wherein the conference identification includes a telephone number.

19. The system of claim 17, wherein the conference identification includes an extension.

20. The system of claim 16, wherein the original call is a voice call and the destination number is compatible with text.

21. The system of claim 16, wherein the original call is a text call and the destination number is compatible with voice.

22. The system of claim 21, wherein determining if the original call is compatible with the destination number includes prompting a user for a request for relay service.

23. The system of claim 16, wherein determining if the original call is compatible with the destination number includes receiving a DTMF response.

24. The system of claim 16, wherein determining if the original call is compatible with the destination number includes receiving a voice response.

25. The system of claim 16, wherein determining if the original call is compatible with the destination number includes detecting text tones in the original call.

26. The system of claim 16, wherein determining if the original call is compatible with the destination number includes accessing a database to retrieve pre-stored information associated with the originating number.

27. The system of claim 16, wherein determining if the original call is compatible with the destination number includes detecting information within data fields of the original.

28. The system of claim 16, wherein connecting the original call to the destination number includes enabling voice and text communication between the call center and the destination number.

29. The system of claim 28, further comprising a telephone including an addressable display to display received text communication, the telephone associated with the destination number.

30. The system of claim 16, wherein connecting the original call to the destination number includes enabling voice communication between the originating number and the destination number.

31. A computer readable medium having stored thereon computer readable instruction code for performing a method for conferencing in a relay service into a call between a user and an impaired user, the method comprising:
receiving an original call from an originating number;
determining if the original call is compatible with a destination number;
upon determining incompatibility, placing a request call to a call center to request relay service to provide voice translation of text communication;
receiving a relay call from the call center and conferencing the relay call into the original call; and
connecting the original call to the destination number.

32. The computer readable medium of claim 31, wherein placing a request call includes,
mapping a conference identification to the original call, and
transmitting a conference identification to the call center, and
wherein receiving the relay call includes receiving the conference identification.

33. The computer readable medium of claim 32, wherein the conference identification includes a telephone number.

34. The computer readable medium of claim 32, wherein the conference identification includes an extension.

35. The computer readable medium of claim 31, wherein the original call is a voice call and the destination number is compatible with text.

36. The computer readable medium of claim 31, wherein the original call is a text call and the destination number is compatible with voice.

37. The computer readable medium of claim 36, wherein determining if the original call is compatible with the destination number includes prompting a user for a request for relay service.

38. The computer readable medium of claim 31, wherein determining if the original call is compatible with the destination number includes receiving a DTMF response.

39. The computer readable medium of claim 31, wherein determining if the original call is compatible with the destination number includes receiving a voice response.

40. The computer readable medium of claim 31, wherein determining if the original call is compatible with the destination number includes detecting text tones in the original call.

41. The computer readable medium of claim 31, wherein determining if the original call is compatible with the destination number includes accessing a database to retrieve pre-stored information associated with the originating number.

42. The computer readable medium of claim 31, wherein determining if the original call is compatible with the destination number includes detecting information within data fields of the original.

43. The computer readable medium of claim 31, wherein connecting the original call to the destination number includes enabling voice and text communication between the call center and the destination number.

44. The computer readable medium of claim 43, further comprising displaying text received from the call center on an addressable telephone display associated with the destination number.

45. The computer readable medium of claim 31, wherein connecting the original call to the destination number includes enabling voice communication between the originating number and the destination number.

46. A method for conferencing in a relay service into a call between a user and an impaired user, comprising:
receiving an original voice call from a user at an originating number;
determining if the original voice call is compatible with a destination number;
upon determining incompatibility, placing a request call, including a conference identification mapped to the original voice call, to a call center to request relay service to provide voice translation of text communication;
receiving a relay call and the conference identification from the call center and conferencing the relay call into the original call; and
connecting the original call to the destination number to enable text communication between the destination number and the call center.
